(19) United States
(12) Patent Application Publication
(10) Pub. No.: US 2012/0181110 A1
(43) Pub. Date: Jul. 19, 2012

(54) TREESTAND WITH 360 DEGREE UNOBSTRUCTED VIEWS

(76) Inventor: Daniel Adam Browning, Hiram, GA (US)

(21) Appl. No.: 13/008,922

(22) Filed: Jan. 19, 2011

(51) Int. Cl. A01M 31/02

(52) U.S. Cl. 182/113; 182/129; 182/115

(57) ABSTRACT

Described herein is a tree stand that includes a platform that substantially surrounds a trunk of a tree, a chair that moves from one end of the platform to the other, and a seat that swivels. This tree stand allows the hunter to have an unobstructed 360 degree view whereby he or she may see game in all directions. The tree stand may also include steel teeth, ratchet straps, columns, and a ladder to provide support for the platform. The platform is adjustable to various elevations on the tree.

### FIELD OF INVENTION

This invention relates to a stand to be used on trees, poles, or other columns. The invention relates to a stand that provides the user a 360 degree view from his seated location. This view is not obstructed by the tree, pole or column.

### BACKGROUND

Tree stands are a popular and very successful way to hunt deer and other game. Tree stands are most commonly chairs or seats connected to a platform that is elevated and fastened to a tree. The back of the chair is fastened to a tree and the platform is to rest the users' feet. A hunter will use a tree stand to remain seated in the chair while waiting above the game. Using a well placed stand allows the hunter to conceal his movements from the game he is hunting. The added benefit of a stand is that the hunter is placed 10-15 feet off the ground, so this severely limits two of the main defensive systems of the deer; its sight and sense of smell.

There are many tree stands available in the market. However, most tree stands do not provide the hunter a 360 degree view and the hunter is disadvantaged with blind spots.

The views provided by other stands are obstructed by the tree on which the stand is fastened. This disadvantages the hunter who will not have a complete field of view or will have a diminished shooting angle as they will not be able to see behind them without getting out of the tree stand. Such movement is disadvantageous because it creates noise that may startle the game.

The most typical tree stand is a chair with a back rest fastened to the trunk (U.S. Pat. No. 6,588,546). The seat faces one direction away from the tree. The hunter has a ˜180 degree view. This severely limits the view of the hunter.

This is consistent with most tree stands and ladder stands currently on the market that only allow the user to face one direction. If the hunter wants to see what's behind him, or look to the left or right, he will have to stand up and look behind him or to the left and right of him. This movement not only makes noise, which could potentially scare the game away, but can also cause neck pain from the constant strain of looking behind and to the left and right. Some tree stands have been made to address this problem by adding a swiveling chair; however, the tree on which the stand is attached is still obstructing the 360 degree view of the hunter.

### SUMMARY OF THE INVENTION

Accordingly, one objective of the present invention is to provide a tree stand to address these limitations. This tree stand has been developed to eliminate blind spots and provide hunters a 360 degree, complete field of view without a tree obstructing the view while the hunter may remain silent. The platform of the stand at least partially surrounds the trunk of the tree. Complete field of view is obtained by a swivel chair. The arm of the chair also rotates so that the chair will move from one side of the platform to the other.

However, it is recognized that this invention may be used for other purposes such as being used on any pole or column where an unobstructed view is desired. These are only examples of some of the embodiments of the present invention, other uses and advantages will become apparent hereinafter in the specification and the drawings.

### BRIEF DESCRIPTION OF THE DRAWINGS

FIG. 1 is a vertical cross section of the tree stand showing: the platform fixed against the trunk of the tree; the chair; the arm of the chair, which is mounted to the platform; support beams going from the platform to the trunk, and a ratchet strap securing the platform to the tree.

FIG. 2 is an aerial view of the layout of the platform.

FIG. 3 is the top view showing the chair's range of movement from one end of the platform to the other.

FIG. 4 is a cross section of the chair.

### DETAILED DESCRIPTION OF THE DRAWINGS

Embodiments of this invention generally refer to a tree stand comprising a platform and a chair affixed to the trunk of a tree (hereinafter “tree”). The chair 25 has an arm 30 that is mounted to the platform, preferably the center of the platform. The arm 30 of the chair 25 has two arm elements 31, 32 that allow the chair 25 to swivel from one end of the platform 20a to the other 20b. The seat 20 of the chair 25 itself swivels 360 degrees.

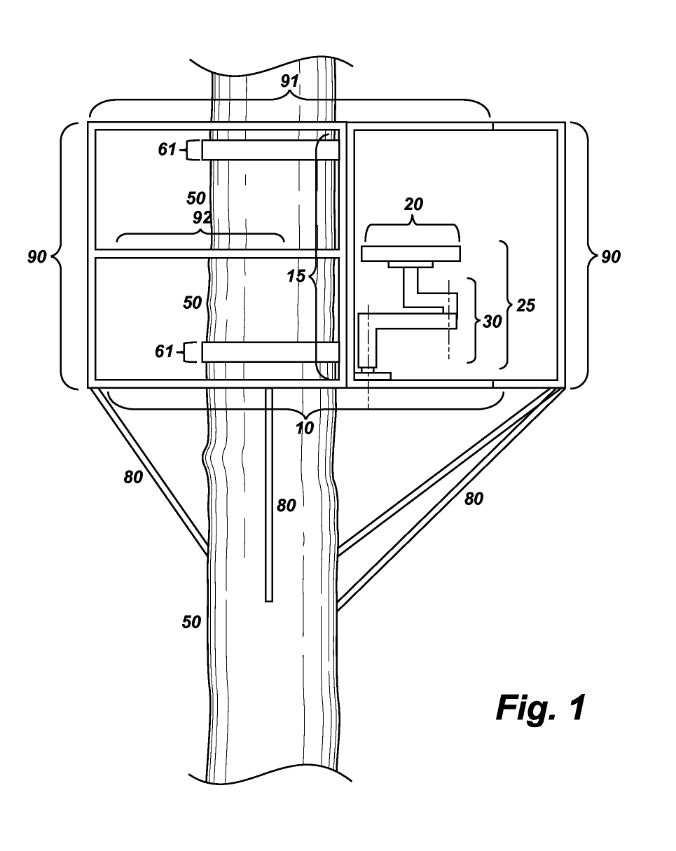

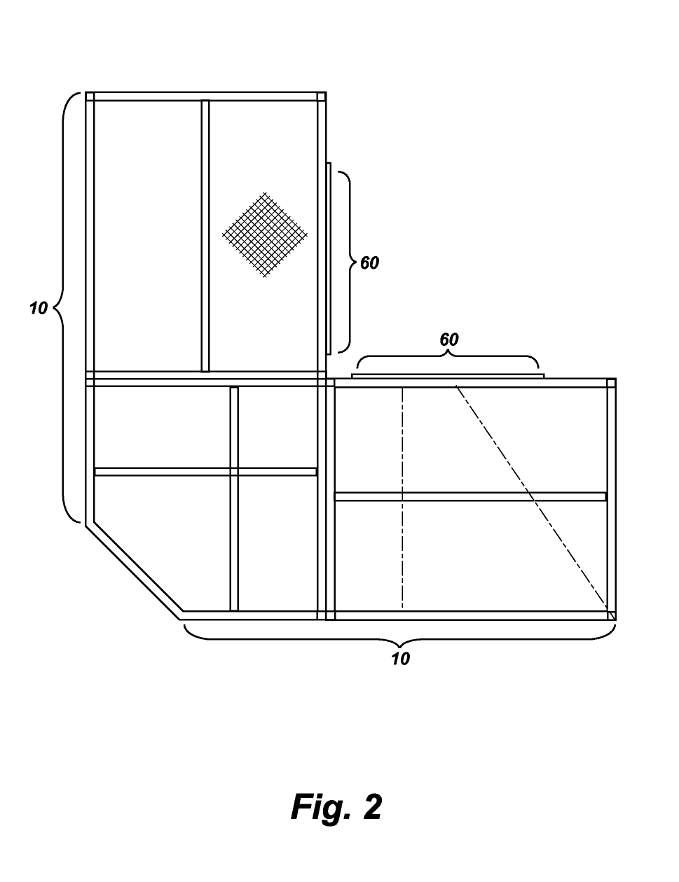

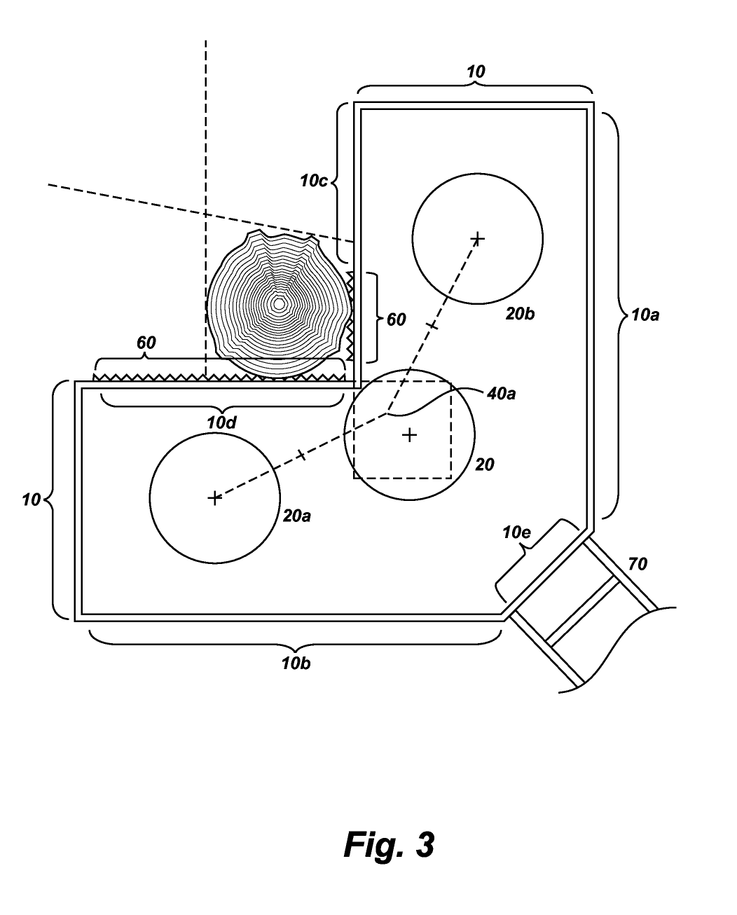

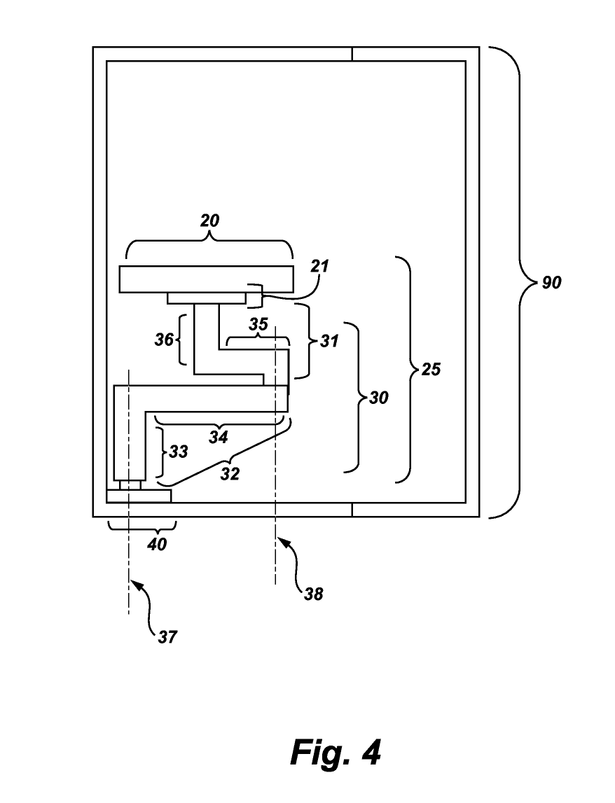

Referring to the drawings, simultaneous reference will be made to FIGS. 1-4. FIG. 1 illustrates a vertical cross section of the tree stand. FIG. 2 shows the layout of the platform. FIG. 3 is the top view showing the chair's range of motion from one end of the platform to the other side of the platform. And FIG. 4 is a cross section of the chair.

A platform 10 substantially surrounds a tree 50, pole, or column. FIG. 3 shows one embodiment of the platform around the tree. The platform 10 is affixed to the tree 50 by known means in the art; some methods will be shown hereafter. A chair 25 is mounted to the platform 10 through an arm 30. The arm 30 may rotate causing the chair 25 to move horizontally from one end of the platform 20a to the other 20b. Additionally, the seat 20 may swivel 360 degrees itself.

In a preferred embodiment of the invention, the platform 10 surrounds the tree 50 enough so the full range of motion from the chair 25, from one end of the platform to the other, will collectively provide a hunter, or other user, an unobstructed view in all 360 degrees from the center of the platform. Accordingly, the length of the platform 10 may vary adapted to the length of the tree 50. In another embodiment of the invention, the platform 10 will surround the tree 50 enough so the full range of motion from the chair 25 will collectively provide a hunter, or other user, an unobstructed view of substantially 360 degrees from the center of the platform. In another embodiment, the platform 10 will completely surround the tree 50, pole, or column.

Referring to FIG. 3, in a preferred embodiment, the platform 10 will have a longitudinal sides 10a/c and a lateral sides 10b/d. The longitudinal side 10c and the latitudinal side 10d will be affixed or in contact to the tree 50, pole, or column. In one embodiment, the inside base of the platform 10c/d has a tree gripping device 60. One example of a tree gripping device 60 is steel teeth 60 that bite into the tree 50 for support. The steel teeth are affixed to the inside base of the platform 10c/d and the teeth pierce into the bark of the tree 50 to support the platform 10. Other similar gripping devices known in the art may also be used. In some embodiments, the tree gripping device 60 is also affixed to the lateral support 15. And in other embodiments, the tree gripping device 60 is affixed to the inside base of the platform 10c/d and the lateral support 15.

In a preferred embodiment, the platform 10 may also be supported on the tree 50 with a ratchet strap 61 that connects to the inside base of the platform 10c/d and wraps around the tree 50, strapping the stand to the tree 50. The platform may also have a lateral support 15 on the inside of the stand, along the inside base of the platform 10c/d. The lateral support 15 is affixed to the platform 10c/d and is perpendicular to the tree 50. The ratchet straps 61 may also attach to the lateral support 15. The chair 25 is mounted, preferably to the center 40a, of the platform through an arm 30. The platform 10 may be made of any material known in the art.

The platform may be affixed to the tree in a variety of ways. FIG. 1 shows support beams 80 that connect to the platform 10 and provide support by connecting to the tree 50. In a preferred embodiment, the support beams 80 are permanently affixed to the outer part of the platform 10 and to the tree 50. Multiple support beams 80 will provide greater support, though there is no specified amount of support beams 80 necessary. The support beams 80 can be made to connect and disconnect to the platform 10 through any known means of connection/disconnection in the art. Where the support beams 80 are integrally and permanently attached to the platform 10 it may be constructed in a manner that allows the beams to fold up or collapse.

The invention may be constructed as a portable stand that may be collapsed and assembled. Construction of the stand will allow for the elevation of the platform 10 to be adjustable so that it may be at a desired elevation. The elevation of the stand will depend on how high the stand is fastened to the tree 50. All individual parts of the stand may be constructed using materials known in the art.

A ladder 70 may be attached to the platform 10. In one embodiment, the ladder 70 may collapse and fold up. In another embodiment the ladder 70 attaches to the platform 10 for sturdiness. The ladder 70 may also provide support for the platform 10.

The stand may also have rails 90-92 on the perimeter of the platform to provide protection for the user or hunter from falling off. In one embodiment, the rails 90-92 enclose the entire perimeter. The rails 90-92 may vary in height, with perspective to the platform 10. If a ladder 70 is used, generally the rails 90-92 will not extend the entire length of the platform 10e where the ladder 70 would rest or attach to allow someone to enter the stand. In some embodiments where the rails 90-92 do extend the entire perimeter, a door may be used to provide one access to the platform 10 from the ladder 70.

The chair 25 is mounted to an arm 30 that is mounted to the platform 10. The chair 25 is mounted to the arm 30 in a manner that allows it to swivel 360 degrees. Any seat-mounting-swivel technology 21 may be employed that is already known in the art.

The arm 30 of the chair 25 is comprised of two arm elements 31, 32. The first arm element 32 is mounted to the platform 10, preferably in the center 40a. In one embodiment, the first arm element 32 comprises two bars 33, 34 connected in a right angle. In another embodiment, the first arm element 32 is one bar in the shape of a right angle. The first arm element 32 has a vertical bar 33 that is mounted to the platform 10, and a horizontal bar 34 that connects to the second arm element 31. The second arm element 31 connects to the first arm element 32 and the seat 20 of the chair 25. The second arm element 31 is a bar in the shape of a right angle. In another embodiment, the second arm element 31 has a horizontal bar 35 that is attached to a vertical bar 36 in a right angle. The horizontal bar 35 is attached to the seat 20 at 21. The seat 20 is mounted to the arm 30 of the chair 25 in a manner that allows the seat 20 to swivel 360 degrees.

In one embodiment, the first (vertical) arm element 33 will be mounted to the center of the platform 40. The first (horizontal) arm element 34 will be facing outwards, away from the tree 50. The second (horizontal) arm element 35, will be facing inward, toward the tree 50. The second (horizontal) arm element 35, will not be as long as the first (horizontal) arm element 34, generally being half as long to make room for the seat 20. In some embodiments, the diameter of the seat 20 will be twice as long as the diameter of the second (horizontal) arm element 35, or as long as the diameter first (horizontal) arm element 34. This is but one example, the lengths of the arm elements 34, 35 may vary, as well as the diameter of the seat 20.

The first arm element 32 will rotate about the axis 37 where it is mounted. That will allow the first arm element 32 to rotate from one end 20a of the platform to the other end 20b. Initially, the second arm element 31 will be facing the tree, in the opposite direction of the first arm element 32. The second (horizontal) arm element 35 may rotate about the axis 38, in a direction away from the tree 50. The rotation of the second arm element 31 in conjunction with the rotation of the first arm element 32 will allow the seat 20 to extend even further from one end of the platform 20a to the other 20b. The extension of the seat from one end of the platform 20a to the other 20b is what allows the hunter to view all angles around the tree 50 and eliminates blind spots. This in combination with the swivel chair 20 allows the user to view any angle while remaining seated.

In one embodiment, the seat 20 has a lock to prevent it from swiveling. In another embodiment the arm 30 of the chair 25 has a lock to prevent it from swiveling. Locking both will fix the seat's 20 location. While one benefit of this invention is to allow the hunter to view any angle, it is recognized that a user may want to focus on one direction. Locking the seat 20 and/or chair 25 in place allows the hunter the flexibility to view all angles or focus in one direction.

There are other mechanical configurations in which the seat 25 may be configured to move from one end 20a of the platform 10 to the other 20b.

The features of the present invention allow a hunter to remain seated and clearly view any direction, unobstructed without getting up. This further allows a hunter to view any direction without straining his or her neck. The seat 20 of the tree stand will swivel from end 20a of the platform 10 to the other 20b. This provides the hunter a view around the tree 50 on which the stand is fastened. The seat 20 also swivels providing a view of 360 degrees.

While the preferred embodiment of the invention is for a hunter, this stand may be used for any pole or column where the user needs an unobstructed view of 360 degrees.

I claim:

1. A tree stand comprising:
a platform
wherein the platform at least partially surrounds the trunk of a tree, and
a seat
wherein the seat is attached to an arm that is mounted on the platform, and
wherein the arm rotates and allows the seat to move from one end of the platform to the other end.

2. The tree stand of claim 1, wherein the seat swivels 360 degrees.

3. The tree stand of claim 1, wherein the platform has a longitudinal side and a latitudinal side shaped like an “L”.

4. The tree stand of claim 1, wherein the platform is a circle that completely surrounds the tree.

5. The tree stand of claim 1, wherein the platform has rails along the perimeter.

6. The tree stand of claim 1, wherein the platform is attached to a ladder.

7. The tree stand of claim 1, wherein the inner side of the platform has a tree gripping device.

8. The tree stand of claim 1, wherein the platform is attached to the tree with a ratchet strap.

9. The tree stand of claim 1, wherein support beams are attached to the platform.

10. The tree stand of claim 1, where in the seat has a lock to prevent it from swiveling.

11. The tree stand of claim 1, where in the arm has a lock to prevent it from swiveling.

12. A tree stand comprising:
a platform
wherein the platform at least partially surrounds the trunk of a tree, and
a chair
wherein the chair is capable of moving from one end of the platform to the other end.

13. The tree stand of claim 12, wherein the chair is comprised of a seat that swivels 360 degrees.

14. The tree stand of claim 12, wherein the platform is attached to a ladder.

15. The tree stand of claim 12, wherein the inner side of the platform has a tree gripping device.

16. The tree stand of claim 12, wherein the platform is attached to the tree with a ratchet strap.

17. The tree stand of claim 12, wherein support beams are attached to the platform.

18. A tree stand comprising:
a platform
wherein the platform at least partially surrounds the trunk of a tree, and
wherein the inner base of the platform comprise a tree gripping device that allows the platform to attach to the trunk of a tree, and
a chair
wherein the chair is capable of moving from one end of the platform to the other end.

19. The tree stand of claim 18, wherein the chair comprises a seat that swivels 360 degrees.

20. The tree stand of claim 18, additionally comprising support beams and a ladder.
